(19) United States
(12) Patent Application Publication
(10) Pub. No.: US 2012/0081991 A1
(43) Pub. Date: Apr. 5, 2012

(54) PISTON AND A CONTAINER WITH SUCH A PISTON

(75) Inventor: Jan Svensson, Huskvarna (SE)

(73) Assignee: INTRADRUG MEDICAL SYSTEMS AB, SE-561 25 Huskvarna (SE)

(21) Appl. No.: 13/377,553

(22) PCT Filed: Jun. 10, 2010
(86) PCT No.: PCT/SE2010/000163

§ 371 Date: Dec. 10, 2011

(30) Foreign Application Priority Data
Jun. 11, 2009 (SE) 0900798-0

(51) Int. Cl. B01F 13/00; G01F 11/00

(52) U.S. Cl. 366/130; 222/386

(57) ABSTRACT

The invention relates to a piston (4) with a sealing element (7, 7a-b) for slideably sealing a container (1) with an essentially cylindrical inner surface. The sealing element (7, 7a-b) comprises an inner portion (7b) aligned against the piston and an outer ring portion (7a) which extends in a ring shape around the circumference of the piston and is arranged to engage the inner surface of the container (1). The outer ring portion is arranged to flex inwards towards the centre axis of the piston (4) when the piston is displaced inside container (1) in a first direction and the outer ring portion is arranged to flex outwards towards the inner surface of the container (1) when the piston is displaced inside the container (1) in second direction being opposite the first direction. At least a first ring shaped groove extends in a ring shape on a first side of the sealing element (7, 7a-b), said groove being arranged between the inner portion (7b) and the outer ring portion (7a) of the sealing element.

### BACKGROUND AND SUMMARY

The present invention relates to a piston and a container with such a piston.

Devices for storing, mixing and dispensing of at least two substances are known. Typically, such devices may be used for separately storing a dry substance and a liquid, where the liquid and the dry substance then may be mixed and dispensed at a suitable occasion. Known such devices require a comparatively complex design in order to provide all these three uses.

It is desirable to provide a piston which allows providing such a device for storing, mixing and dispensing of at least two substances which is simpler in its design and cheaper to produce.

The invention relates, according to an aspect thereof, to a piston 4 with a sealing element 7, 7a-b for slideably sealing a container 1 with an essentially cylindrical inner surface. The sealing element 7, 7a-b comprises an inner portion 7b aligned against the piston and an outer ring portion 7a which extends in a ring shape around the circumference of the piston and is arranged to engage the inner surface of the container 1. The outer ring portion is arranged to flex inwards towards the centre axis of the piston 4 when the piston is displaced inside container 1 in a first direction and the outer ring portion is arranged to flex outwards towards the inner surface of the container 1 when the piston is displaced inside the container 1 in second direction being opposite the first direction. At least a first ring shaped groove extends in a ring shape on a first side of the sealing element 7, 7a-b, said groove being arranged between the inner portion 7b and the outer ring portion 7a of the sealing element. This design of the sealing element advantageously separates substances held inside the container above and below the piston, unless a sufficient pressure is applied. If a sufficient pressure is applied in a correct direction, the seal allows one of the substances to pass and mixed with the other, while if pressure is applied in the opposite direction, the seal does not allows either of the substances to pass.

In a particularly advantageous embodiment of the invention, a second ring shaped groove extends in a ring shape on a second side of the sealing element 7, 7a-b. The second groove is arranged between the inner portion 7b and the outer ring portion 7a of the sealing element, and the first groove is deeper than the second groove. This embodiment further emphasizes the unidirectionality of the sealing element.

In yet another advantageous embodiment of the invention, the outer ring portion 7a of the sealing element 7, 7a-b is attached to the inner portion 7b of the sealing element along a ring shaped attachment area which extends around its periphery. The outer ring portion 7a extends further from the attachment area in a first direction being perpendicular to the centre axis of the piston, than in a second direction being opposite the first direction.

The invention further relates to a device for storing, mixing and dispensing of at least two substances. It comprises a container 1 with an essentially cylindrical inner surface and a piston with a sealing element 7, 7a-b for slideably sealing the container 1. The container 1 is at a first end arranged to comprise a spout 2. The sealing element 7, 7a-b comprises an inner portion 7b aligned against the piston and an outer ring portion 7a which extends in a ring shape around the circumference of the piston and is arranged to engage the inner surface of the container 1. The outer ring portion is arranged to flex inwards towards the centre axis of the piston 4 when the piston is displaced inside container 1 in a first direction and the outer ring portion is arranged to flex outwards towards the inner surface of the container 1 when the piston is displaced inside the container 1 in second direction being opposite the first direction.

In a particularly advantageous embodiment, the device Tor storing, mixing and dispensing may comprise a sealing element with a second ring shaped groove extending in a ring shape on a second side of the sealing element 7, 7a-b. The groove is arranged between the inner portion 7b and the outer ring portion 7a of the sealing element, and the first groove is deeper than the second groove.

The device may advantageously be provided with a piston rod 5, 5a-b attached to the piston 4, where the piston rod 5, 5a-b extends in the direction of the second end of the container 1, and where the container comprises and upper piston 8 slideably arranged inside the container. The device may further advantageously be provided a locking device 11, 12 that may lock together the piston 1 and the upper piston 8. This means that as the piston has been pushed against the upper piston, mixing the substances in the process, both piston rods may jointly be pushed towards the spout and dispensing the mixture.

### BRIEF DESCRIPTION OF THE DRAWINGS

FIG. 1a shows a first embodiment of the invention filled with liquid in the space between the spout and the piston

FIG. 1b shows a detail of the first embodiment with an open passage between the sealing element and the upper part of the container

FIG. 2a shows the first embodiment of the invention with the sealing element sealing the upper part of the container

FIG. 2b shows a detail of the first embodiment

FIG. 3 shows the first embodiment with an upper piston

FIG. 4 shows the first embodiment during the mixing phase

FIG. 5 shows the first embodiment with fully mixed contents

FIG. 6 shows the first embodiment during the dispensing phase

FIG. 7 shows the upper and lower pistons in greater detail

FIG. 8 shows in greater detail the upper and lower pistons locked together

FIG. 9 shows a cross section of a second embodiment of the lower piston

FIG. 10 shows the second embodiment of the lower piston

FIG. 11 shows the second embodiment of the lower piston with an opening device

FIG. 12 shows a second embodiment of the invention in the storage phase

FIG. 13 shows a second embodiment of the invention after mixing

FIG. 14 shows a second embodiment of the invention after dispensing

FIG. 15 shows a third embodiment of the invention in the storage phase

FIG. 16 shows the third embodiment of the invention after mixing

FIG. 17 shows the third embodiment of the invention after dispensing

FIG. 18 shows a fourth embodiment of the invention in the storage phase

FIG. 19 shows the fourth embodiment of the invention after mixing

FIG. 20 shows the fourth embodiment of the invention after dispensing

FIG. 21 shows a fifth embodiment of the invention

FIG. 22 shows a detail of the fifth embodiment

FIG. 23 shows a second detail of the fifth embodiment

FIG. 24 shows the second detail of the fifth embodiment in cross section

FIG. 25 shows a sixth embodiment of the invention in a first stage of the filling process

FIG. 26 shows the sixth embodiment of the invention in a second stage of the filling process

FIG. 27 shows the sixth embodiment of the invention in a third stage of the filling process

FIG. 28 shows a seventh embodiment of the invention in a first position

FIG. 29 shows the seventh embodiment of the invention in a second position

FIG. 30 shows an eighth embodiment of the invention in a first position

FIG. 31 shows the eighth embodiment of the invention in a second position

FIG. 32 shows the eighth embodiment of the invention in a third position

### DETAILED DESCRIPTION

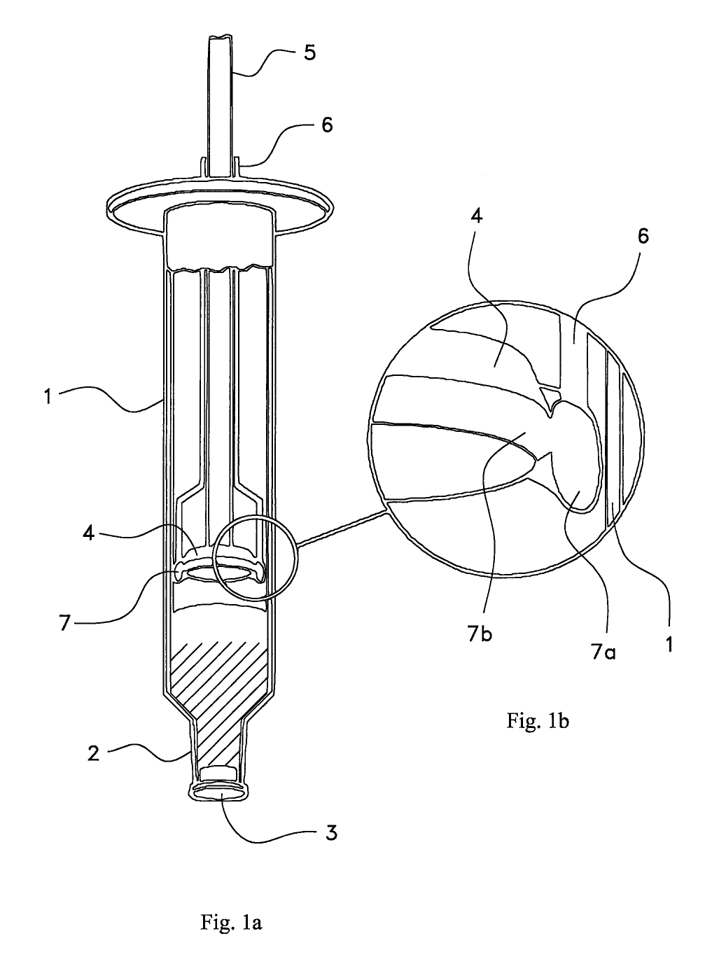

FIG. 1 a shows a first embodiment of the invention filled with liquid. The figure illustrates a device for storing, mixing and dispensing substances, which is embodied as a syringe. The device comprises an essentially cylindrical container 1 with a spout 2 arranged at a first end of the container, while the other end is open. The spout 2 is in the figure closed with a lid 3. A lower piston 4 is provided in the container, to which a piston rod 5 is attached, which extends upwards towards the open end of the container. A sealing element 7 is arranged around the piston 4, which is more clearly illustrated in FIG. 1b. A first embodiment of an opening device 6 extends around the piston rod 5. The opening device has a narrower upper portion which preferentially is cylindrical and surrounds the piston rod, and this portion out of the open second end of the container, allowing access to and handling of the opening device. The opening device widens at its lower position and forms a cylindrical detail that touches the inner walls of the container. The opening device may slide along the piston rod and the container. At its lower end, the opening device is cut at an angel, with the cutting line directed upwards at an angle against the central axis of the container, as is more clearly illustrated in FIG. 1b.

FIG. 1b shows a detail of the first embodiment, where the opening device 6 pushes against the outer ring portion 7a of the sealing element. The figure illustrates one half of the lower piston 4 with the sealing element 7, the lower portion of the opening device 6 and adjoining parts of the container 1. The sealing element 7 extends in a ring shape around the circumference of the lower piston and comprises an inner portion 7b which lies against the piston and seals it. The sealing element 7 further comprises an outer ring portion 7a being pushed by the opening device, opening a conduit against the cylindrical inner surface of the container.

The figure only illustrates the sealing element in a partial cross section, but the outer ring portion has an essentially elliptical cross section, and the outer ring portion is attached to the outer surface of the inner portion only along part of the elliptical cross section. This leaves ring shaped grooves between the inner portion and the outer portion on the lower side and preferentially also on the upper side, that extend from above and from below. The grooves have a V-shaped cross section, and as the outer ring portion is attached to the inner ring portion above the centre of the outer ring portion, the upper V-shaped groove is shallower and the lower V-shaped groove is deeper. If the piston is forced upwards, the lower V-shaped groove allows the outer ring to bend aside somewhat in the direction of the container centre, allowing pressurized liquid to pass from the volume above the sealing element to the volume below the sealing element. If the piston is forced downwards and/or the sealing element is forced upwards, the outer ring portion is pushed outwards against the inner surface of the container and seals against the inner surface of the container.

In the figure, this functionality is further emphasized by the opening device being inserted into the container. The lower portion of the opening device aligns snugly against the inner surface of the container and is cut at an angle such that its lower edge extends along a conical surface with the cone's top directed upwards in the figure. In cross section, the lower right portion of the opening device forms a surface of a section which is angled towards the centre axis of the container, angled downwards to the left in the figure. The lower portion of the opening device thus extends further down closest to the inner surface of the container and forces the outer ring portion of the sealing element towards the centre of the container. If the piston is pushed downwards using the opening device, the pressure applied by the outer ring portion of the sealing element against the inner surface of the container decreases, which decreases the friction when the piston is to be pushed down using the opening device, but also allows gas to pass from a volume below the sealing element to a volume above the sealing element. This is desirable for example during a freeze drying process, when the liquid in the supplied mixture is evaporated, and is made possible through the action of the opening device, which is a necessity for performing a freeze drying process.

The illustrated embodiment of the opening device is obviously just an example, and the opening device may alternatively have the same width along its full length, thus having an outer diameter equivalent to the inner diameter of the cylindrical container. The opening device may also be provided with a locking device which locks it in place in relation to the piston when the piston and the opening device are introduced into the container prior to the filling phase, or it may be constituted by an part integrated into the piston 4, allowing the opening device to preferably be manoeuvred using the piston rod 5.

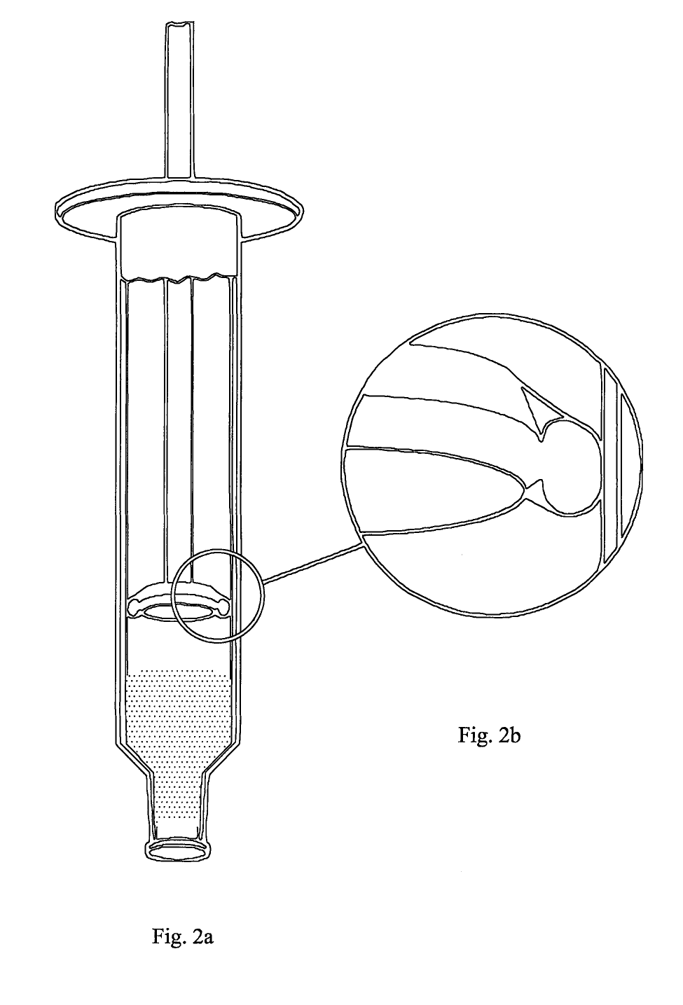

FIG. 2a shows the first embodiment of the invention with the opening device removed. As illustrated particularly clearly in FIG. 2b, the outer ring portion 7a of the sealing element has flexed back to its unloaded state. In the unloaded state, the outer ring portion 7a seals against the inner wall of the container, and bends aside somewhat in the direction of the container centre axis if the lower piston is pulled upwards, while it bends somewhat outwards and seals particularly well if the piston is forced downwards.

In FIG. 2a the device has been filled with a first substance and the lower piston has been pushed downwards using the opening device, such that the container now encloses the first substance in the lower part of the container that is delimited upwards by the lower piston. If a downwards directed force is applied to the piston through the piston rod, thus towards the spout, the sealing element is sealing, and as the substance cannot pass the piston, the piston is prevented form any further downward movement.

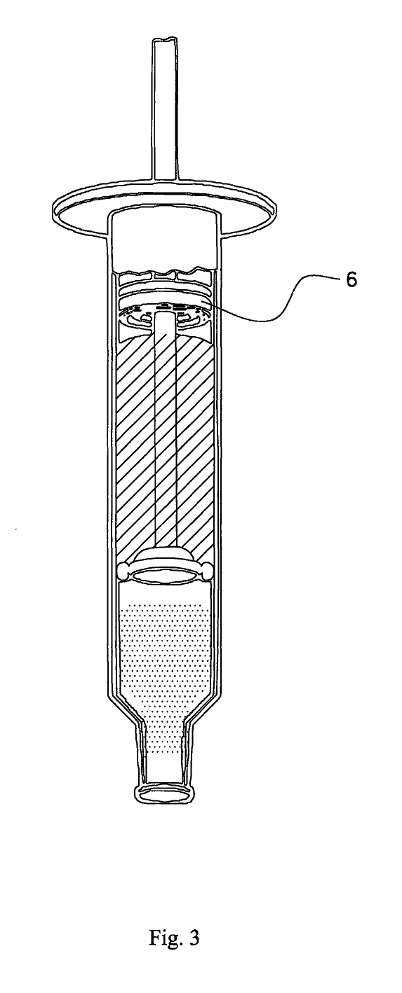

FIG. 3 shows the first embodiment where an upper piston 8 has been introduced into the container above the lower piston. In the filling-process, a first substance is first supplied and the lower piston is pushed downwards using the opening device, such that the first substance fills the first volume in the container closest to the spout, where this volume is delimited by the lower piston. In the figure a second substance has then been supplied above the lower piston and then the upper piston has been introduced, such that the second substance now fills the volume of the container that downwards is delimited by the lower piston and upwards is delimited by the upper piston 8.

The upper piston both comprises sealing element that seal against the piston rod 5 that extends through an opening at the centre of the upper piston, and sealing element that seal against the inner surface of the container. Through the action of the outer sealing element, the upper piston is fixed more thoroughly against the inner surface of the container than against the piston rod, such that if the piston rod is separately pushed in either direction, the upper piston remains fixed in its position in the container.

FIG. 4 shows the first embodiment during the mixing phase, when the lower piston though the action of the piston rod is pushed upwards towards the upper piston, as is illustrated by the two arrows directed upwards. The figure shows how the outer ring portion of the sealing element gives in to the frictional force that acts upon it from the inner surface of the container and from the pressure of the substance in the volume in the container between the lower and upper piston, whereupon it flexes somewhat downwards and the force bearing on the container is decreasing such that substance may pass. Liquid substance from the part of the inner volume of the container that extends between the two pistons passes the sealing element as is illustrated by the two arrows shown on both sides of the lower piston. The substance is there pressed into the inner volume of the container that extends between the spout and the lower piston.

The substances in these two volumes has thus been stored separately from each other until this mixing phase, and being kept separated from each other by the lower piston in a watertight fashion. A conceivable application for this is that the substance stored in the volume closest to the spout is a dry substance that aggregates in a moist environment and becomes useless, which here is prevented. The substance in the upper volume constitutes a solvent for the dry substance. The dry substance is thus stored in the lower volume and remains useable for a longer period of time than would otherwise have been possible, and the two substances are then mixed when needed by pushing the lower piston upwards.

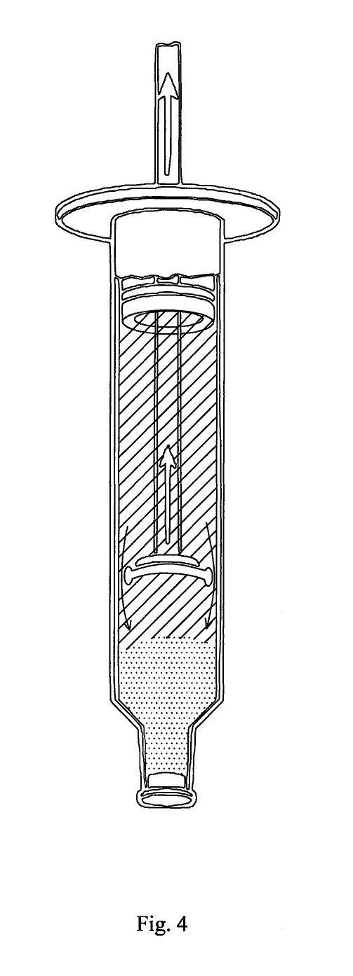

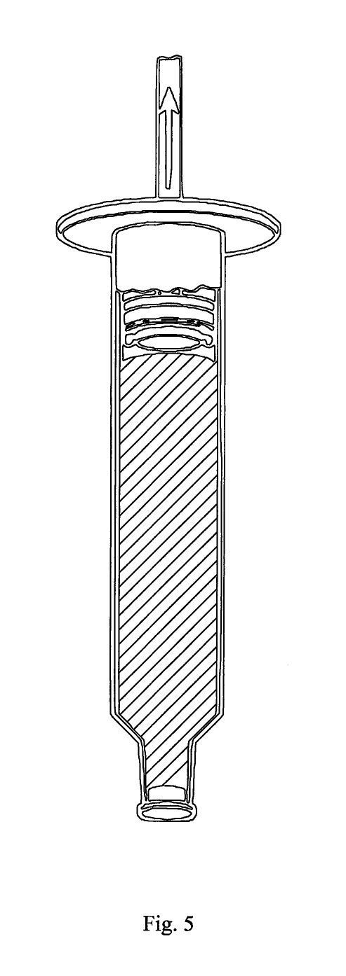

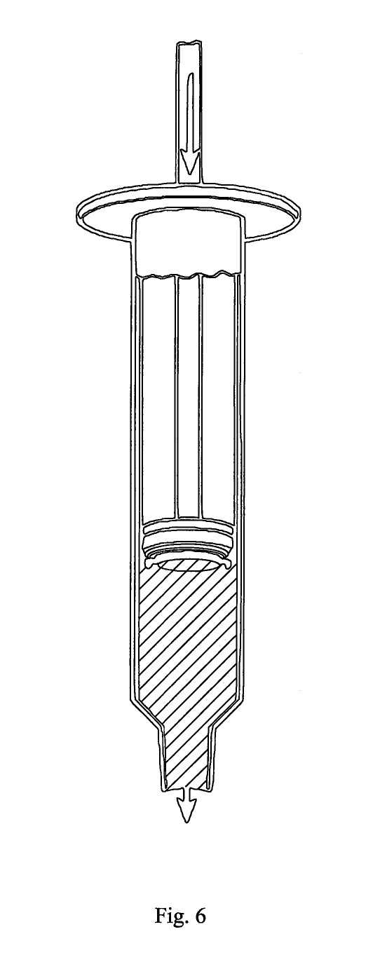

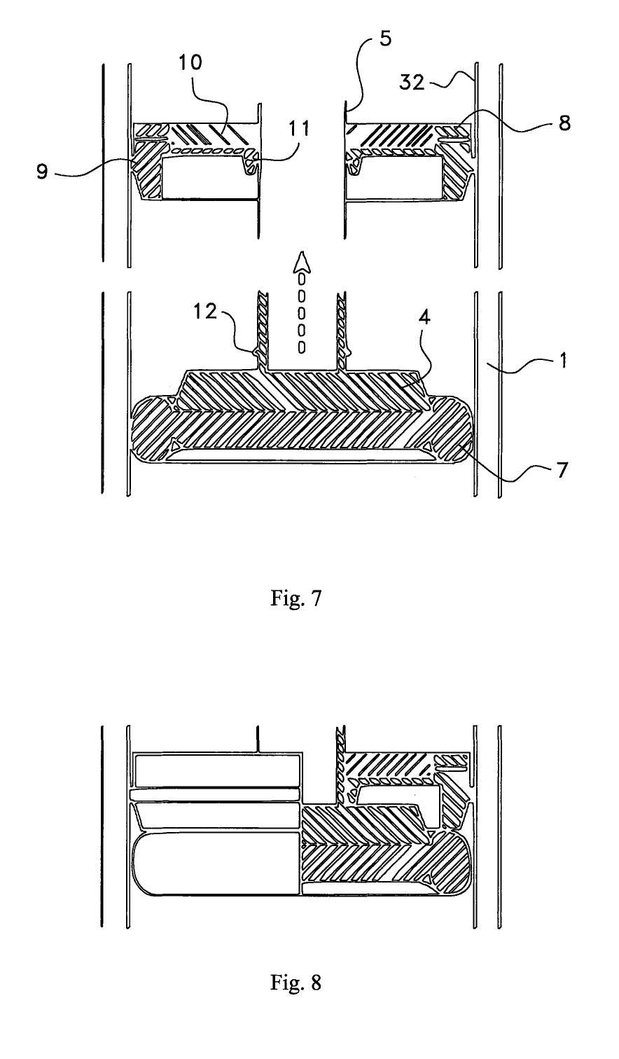

FIG. 5 shows the first embodiment with fully mixed contents, where the lower piston has reached the upper and is situated immediately below this. The two pistons are locked into each other with a device that is illustrated in FIGS. 7-8, and if the piston rod is pushed downwards, both pistons are pushed downwards and force out the mixture of the two substances.

FIG. 6 shows the first embodiment during the dispensing phase, where the piston rod pushes both pistons downwards and the mixture of the two substances are dispensed through the spout. Also, the lid of the spout has been removed allowing the mixture to be dispensed.

FIG. 7 shows the upper 8 and lower 4 pistons in greater detail in a separated position, which is the way they are arranged for storage of the two substances. Both pistons are arranged in the container 1 and seal against its inner walls. The lower piston 4 seals using the outer ring portion of the sealing element 7, while the lower piston seals with an ordinary seal 9 that may slide along the container but is arranged to apply a certain pressure and lie against an upper portion 32 of the container having a reduced inner diameter. The piston rod 5 extends through an opening in the upper piston and is attached to the lower piston. The upper piston seals against the piston rod in a waterproof fashion using an ordinary seal 10. The piston rod slides comparatively easily through the opening in the upper piston and along the seal that is arranged there, such that the upper piston remains in position relative to the container of the piston rod is slid up or down.

The piston rod is cylindrical along the main portion of its length, but at the lower end of the piston rod, a small distance above where it attaches to the lower piston, a ring 12 with a V-shaped cross section extends. The upper piston is in a corresponding way provided with a groove 11 that extends around the central opening in the piston and faces the piston rod. The groove has a V-shaped cross section with the same shape as the ring on the piston. The groove in the upper piston is arranged on a thin, cylindrical element that extends downwards from the central portion of the piston and may flex outwards from the central axis when the lower piston is pushed upwards and the ring is forced into the groove.

FIG. 8 shows in greater detail the upper and lower pistons locked together, where the lower piston has been pushed upwards all the way to the lower edge of the upper piston. The groove 11 in the upper piston has⁻here received the ring 12 on the piston rod, such that the two pistons 4, 8 are interlocked. The ring and the groove locks together the two pistons so well that it takes a larger force pull them apart than it takes to push the two pistons in the container. If a user applies force to the piston rod with the two pistons locked together in this fashion they don't come apart, but the two pistons slide inside the container. This is used to empty the container as illustrated in FIG. 6. Preferably, the piston 8 is provided with a device that forces the outer ring portion 7a to fold downwards against the spout at the piston 4 locked to the piston 8, such that the friction between the outer ring portion 7a and the inner surface of the container is reduced during movement of the piston 4 and the piston 8.

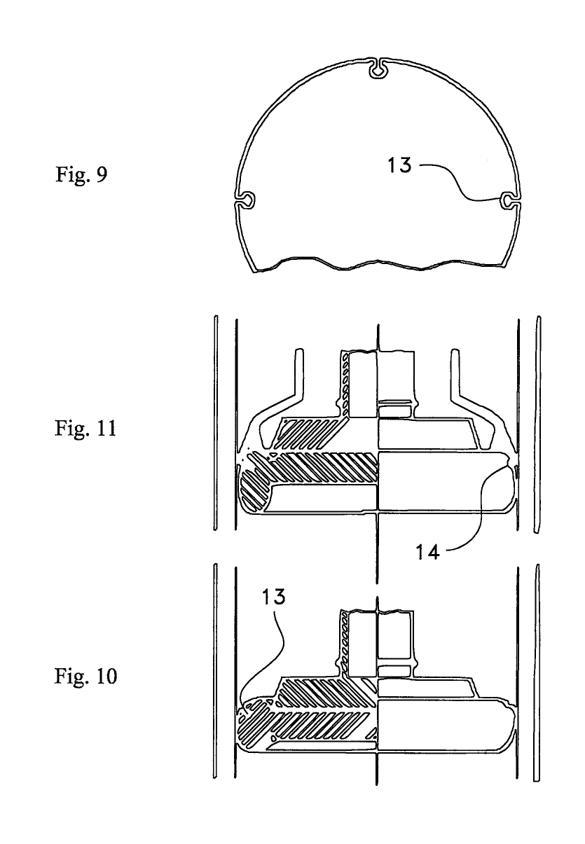

FIG. 9 shows a cross section of a second embodiment of the lower piston. The cross sectional surface extends perpendicularly to the central axis of the piston rod and the surface extends through the piston and the sealing element. The cross section illustrates an essentially circular element with three recesses 13, distributed with a ninety degree angle between consecutive recesses. The recesses have a narrower opening and widen towards the bottom of the recesses. The recesses are arranged in the sealing element and it is provided with four or more such recesses.

FIG. 10 shows the second embodiment of the lower piston seen from the side. The piston is embodied in the same way as the lower piston of the first embodiment illustrated for example in FIG. 7, with exception for the four recesses. The recesses are intended to cooperate with a second embodiment of the opening device illustrated in FIG. 11.

FIG. 11 shows the second embodiment of the lower piston with a second embodiment of the opening device. The opening device is arranged above the lower piston and is intended to be used with a container with a removable lid, such that the container may be filled before the piston and the opening device is inserted into the container. The opening device is aligned against the piston and it is widened where it is aligned against the piston such that it reaches the inner surfaces of the container. The widened portion of the opening device reaches the outer ring portion of the sealing element and is able to force it downwards such that it bends somewhat inwards towards the central axis and achieves an opening between the outer ring portion of the sealing element and the inner surface of the container. This means the piston may be inserted into the container without experiencing any counter pressure, allowing fluids and gases to pass the sealing element during a freeze drying process.

The widened portion of the opening device further comprise four or more grasping claws 14 that extend somewhat above the other parts of the portion, and then angles away towards the centre axis. The grasping claws fit into corresponding recesses 13 and further push away the outer ring portion of the sealing element. If the opening device is pulled upwards, the grasping claws pull the outer ring portion towards its unloaded position, where it seals against the inner surface of the container.

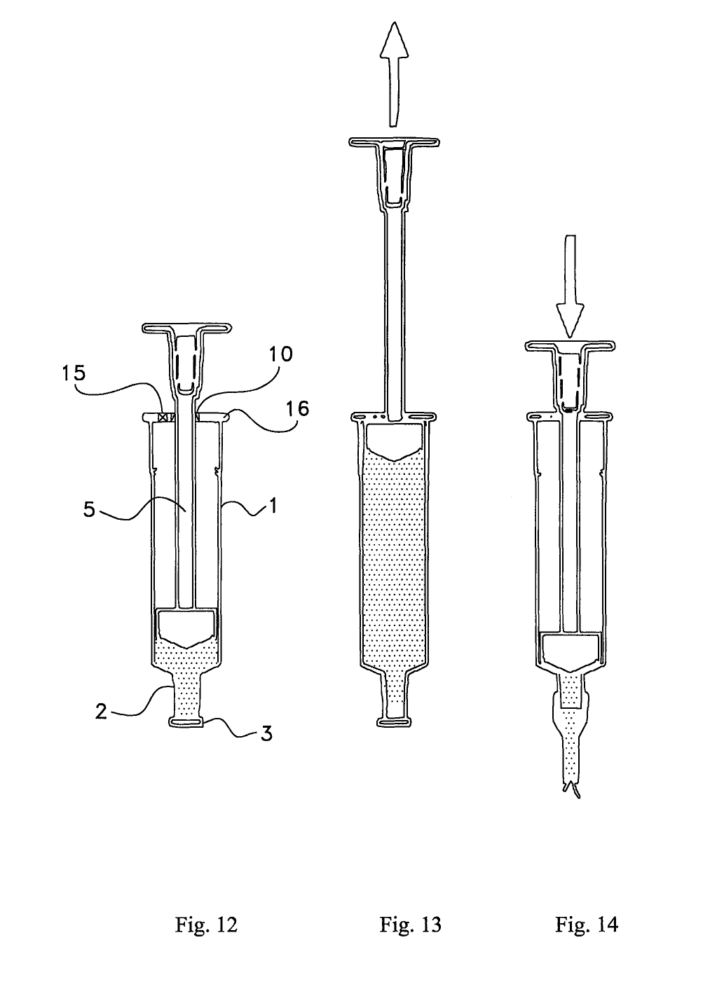

FIG. 12 shows a second embodiment of the invention in the storage phase. This embodiment does, just like the first embodiment, comprise and essentially cylindrical container 1 with a spout 2 at its lower end provided with a lid 3. The container is provided with a piston 4, from which a piston rod extends. The piston rod extends against the upper end of the container and beyond it. At the end that faces away from the piston, the piston rod is provided with a handle, in order to make it possible to apply force to the rod and to facilitate displacing the piston and the piston rod upwards.

At the upper end of the container a stop 16 is provided that covers the upper end of the container with the exception of a centrally positioned opening through which the piston rod may slide. A seal 10 is arranged around the opening which makes the seal between the piston rod and the stop waterproof. In the stop, a release device 15 is arranged which may allow air into the container. The release device 15 may be embodied in several ways, one of which is a filter which is permeable to gas but impermeable to liquid; another is a check valve arranged such that air may pass into the container but flux in the opposite direction is prevented. Alternatively, the release device may comprise a removable, air tight lid which manually or otherwise is removed or put in place in order to control the flux.

The piston may in the same fashion as in the first embodiment be sealed with a sealing element having an inner portion and an outer ring portion, designed as these are in the first embodiment. Alternatively, it works as an ordinary slideable, sealing seal, if through the piston extends a valve which normally seals, but which may open when the pressure difference between the two sides of the piston exceeds a set limit.

FIG. 13 shows a second embodiment of a device according to the invention after mixing, when the piston has been pushed towards the upper end. Substance that was originally stored in the volume between the stop 16 and the piston 4 has been forced beyond the piston and been mixed with the substance that was originally stored in the volume that extends from the spout to the lower surface of the piston. The release device 15 is designed such that when the liquid pressure increases in the upper volume, no liquid gets out of the container through it.

FIG. 14 shows the second embodiment of a device according to the invention after dispensing, when the piston has been pushed downwards and the mixed substances have been emptied through the spout, from which the lid has been removed. The release device 15 has in this process let air into the container in the upper volume, such that the piston may slide downwards without the user having to fight against the air pressure acting on the piston. If the release device is constituted by a check valve or a non liquid permeable filter, this takes place without need for any further manual handling, but if it is constituted by a removable lid, the lid has to be removed when the container is to be emptied after mixing of substances.

FIG. 15 shows a third embodiment of a device according to the invention in the storage phase, which largely corresponds to the second embodiment. The third embodiment lacks a release device in the stop. Instead, a conduit extends through the interior of the piston rod, having openings near where the piston rod attaches to the piston 16a and at the piston near its other end 16b outside the interior of the container. A non illustrated release device is arranged in the conduit, which may be constituted by a check valve or a non liquid permeable filter.

FIG. 15 shows the embodiment in the storage phase, and when the piston is displaced upwards, the substances in the two volumes are mixed without liquid leaving the container and without air entering, through the action of the release device and the sealing element or the valve in the piston.

FIG. 16 shows the embodiment after mixing, and from this position the piston is pushed downwards for ejecting the mixed substances. When the piston is pushed downwards, the release device lets air into the upper volume while the sealing element or valve in the piston forces the mixture out. FIG. 17 shows the third embodiment after dispensing.

FIG. 18 shows a fourth embodiment of a device according to the invention which largely corresponds to the second embodiment. The fourth embodiment too lacks a release device in the stop. Instead, the container has a protruding element 18 arranged on the side of the container near the stop. The protruding element comprises a release device 17 which, in the same way as the second embodiment, may be in the form of a check valve, a non liquid permeable filter or an opening provided with a lid sealing it.

FIG. 18 shows the embodiment in the storage phase, and when the piston is displaced upwards, the substances in the two volumes are mixed without liquid leaving the container and without air being supplied through the action of the release device and the sealing element or the valve in the piston.

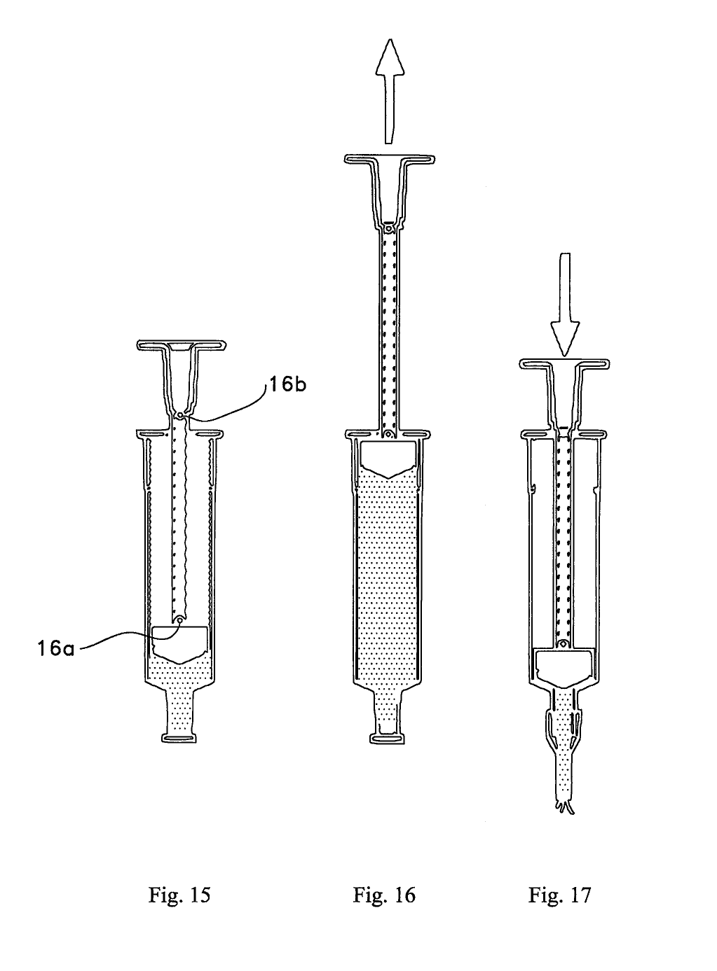

FIG. 19 shows the fourth embodiment after mixing, and from this position the piston is pushed downwards in order to eject the mixed substances. As the piston is pushed downwards, the release device lets air into the upper volume, while the sealing element or valve in the piston forces the mixture out. FIG. 20 shows the fourth embodiment after dispensing.

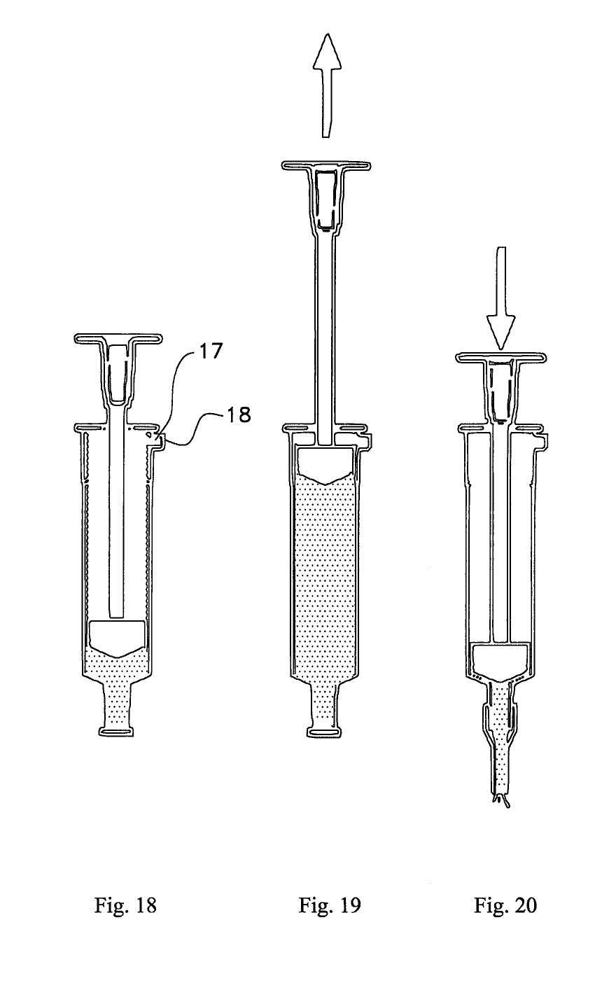

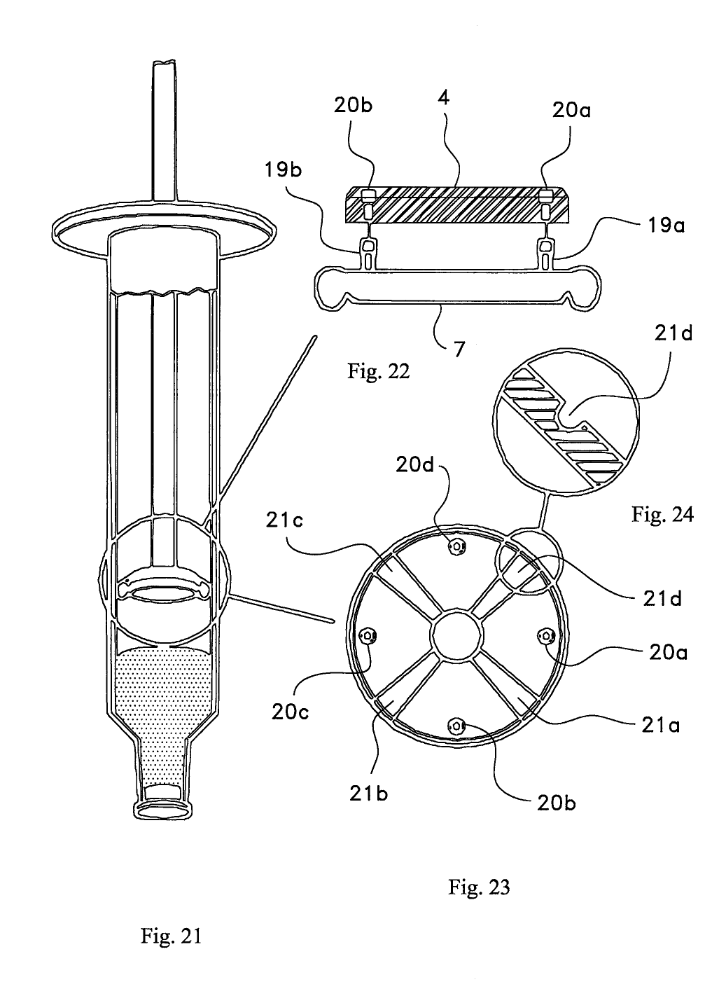

FIG. 21 shows a fifth embodiment of the invention which largely corresponds to the first embodiment, but where the design of the piston 4 and the sealing element 7 deviate. FIG. 22 shows in detail a cross section through the piston 4 and the sealing element 7 of the fifth embodiment. From the upper surface of the piston ring four legs 19a-b extend, having a position at their upper ends. The piston has four corresponding recesses 20a-b, which are also at their widest near the upper surface of the piston. The piston is arranged to receive the four legs 19a-b in the recesses 20a-b and lock the piston ring with the piston.

FIG. 23 shows in greater detail the lower side of the piston of the fifth embodiment. In the figure, the four recesses 20a-d of the piston are more clearly shown, which are arranged near the outer edge of the piston around the piston with a ninety degree angle between consecutive recesses. Between the recesses, four channels 21 a-d are arranged, which extend from the centre of the piston to its outer rim. The channels are arranged with a ninety degree angle between consecutive channels. The channels are intended to leaf liquid away as the lower piston enters and locks into the upper piston, thus making sure all enclosed substances are mixed in an appropriate way. FIG. 24 shows in greater detail a cross section through one of the channels 2 Id in the piston according to the fifth embodiment.

FIG. 25 shows a sixth embodiment of the invention in a first stage of the filling process. The sixth embodiment largely corresponds to the first embodiment, but comprises a separate and removable spout part 22. The spout part does at one end comprise a spout 2 with a lid 3 and is at its other end widened such that it may receive the open end of the cylindrical container 1 into its interior. In FIG. 25 the piston has been positioned for filling about one third of the length of the cylindrical container from the end which is arranged to receive the spout part. In the volume between this end and the piston, a liquid substance for freeze drying has been supplied.

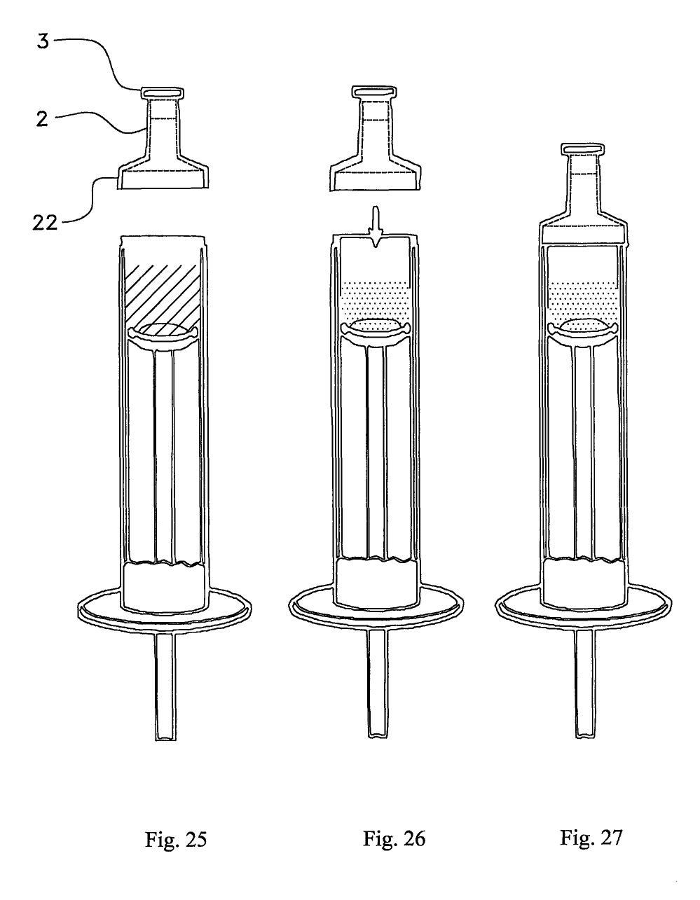

FIG. 26 shows the sixth embodiment of the invention in a second stage of the filling process, where the liquid substance has been freeze dried such that it is now a powder like substance. FIG. 27 shows the sixth embodiment of the invention in a third stage of the filling process, where the spout part has been placed onto the cylindrical container 1.

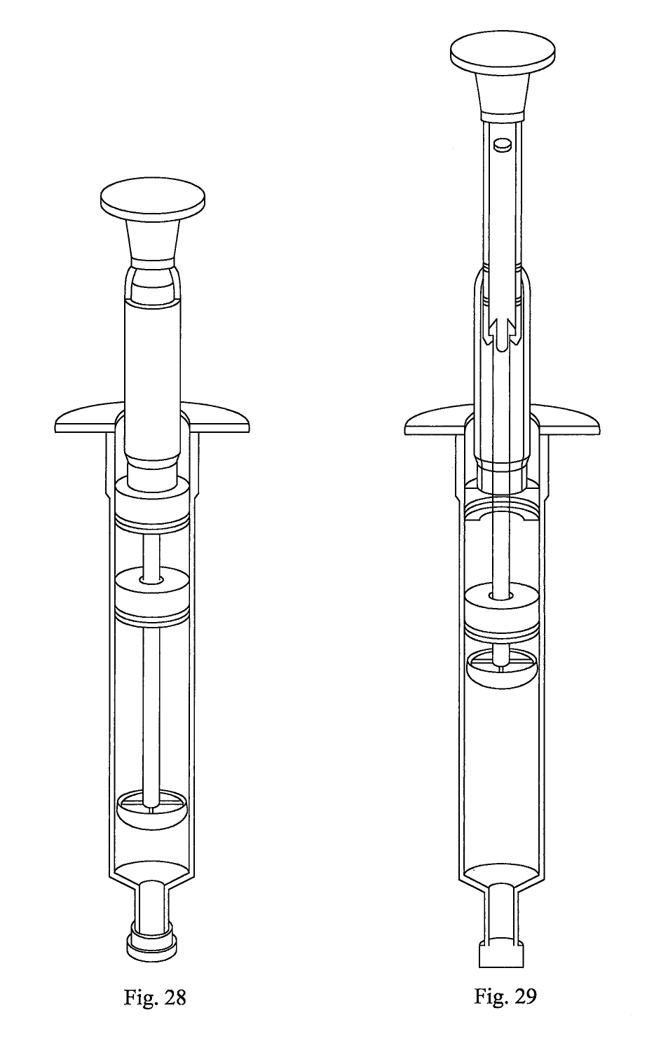

FIG. 28 shows a seventh embodiment of the invention in a first position, where the seventh embodiment not just comprise an upper piston 8 and a lower piston 4 like the first embodiment, but also a middle piston 24 arranged between the upper and lower pistons. To the lower piston, positioned closest to the container spout, a piston rod 5 is attached, which extends towards a handle 25. To the upper piston, a piston rod pipe 26 is attached, which extends cylindrically around the piston rod from the upper piston in the direction of the handle.

In the illustrated first position, the lower piston is positioned in a lower position near the spout, with the upper piston in an upper position near the upper end of the container and the middle piston arranged between the upper and lower pistons. The upper piston and the middle piston are designed in an ordinary fashion as cylindrical parts with an outer diameter nearly corresponding to the inner diameter of the cylinder. The upper piston and the middle piston are around their circumferences provided with sealing rings that seal against the inner surface of the container, but allow the pistons to slide inside the container if a sufficient force is applied to them. The lower piston on the other hand, comprises a sealing element 7, 7a of the kind described in conjunction with the previous embodiments.

FIG. 29 shows the seventh embodiment of the invention in a second position, where the lower piston has been displaced to an upper position somewhat below the middle piston. The figure illustrates the piston rods in partial cross section, such that their design and function is made clear. The piston rod is divided in an upper piston rod portion 5b and a lower piston rod portion 5a. The upper piston rod portion 5b is tube shaped with a cylindrical inner cavity that extends through the upper piston rod portion and is designed to be able to receive the lower piston rod portion 5a. The lower piston rod portion 5a has along the main portion of its extent a smaller outer diameter than the inner diameter of the upper piston rod portion, so that it may be received there.

The lower piston rod portion 5a has at its upper end two latches that extend radially outwards from the outer periphery of the piston rod. The latches have a lower edge that extends nearly perpendicularly from the axial direction of the piston rod, while they at their upper portions are tilted at an angle towards the centre axis of the piston rod. The two latches are arranged facing each other and extending in opposite directions from the central axis of the piston rod. A space is arranged between the two latches and this makes it possible for the two latches to bend slightly inwards but they are arranged to, flex outwardly, such that they are forced against the inner surface of the upper piston rod portion 5b.

The upper piston rod portion 5b has at its lower end a somewhat narrowed inner diametre and this portion interacts with the latches. This interaction makes the lower piston rod portion to follow as the upper piston rod portion is pulled upwards. However, if the upper piston rod portion is pushed downwards, the latches slide freely along the inner surface of the upper piston rod portion, and the lower piston is then not pushed downwards.

The piston rod pipe 26 that extends cylindrically around the piston rod has along the major part of its extent a somewhat larger inner diameter than the upper piston rod portion. The upper end of the piston rod pipe 26 does however have a reduced inner diameter, and engages the upper piston rod portion with a certain spring force. This means that when the upper piston rod portion is pulled upwards and pulls the lower piston with it, the upper piston is not moving.

The upper piston rod portion 5b has at its lower end two ring shaped portions 28a, b that protrude from its outer surface and extend around it. The lower one of these ring shaped portions 28b is arranged near the lower end of the upper piston rod portion, and the upper ring shaped portion 28a is arranged above it at a certain distance. When the upper piston rod portion is pulled up through the piston rod pipe, the upper end of the piston rod pipe, having a reduced diametre, is pulled over the lower one of the ring shaped portions 28b. As the handle 25 then pushes the piston rod downwards, the upper end of the piston rod pipe with its reduced diameter, is unable to return to above the upper ring shaped portion 28a, and the piston rod the forces down the piston rod pipe with the upper piston too.

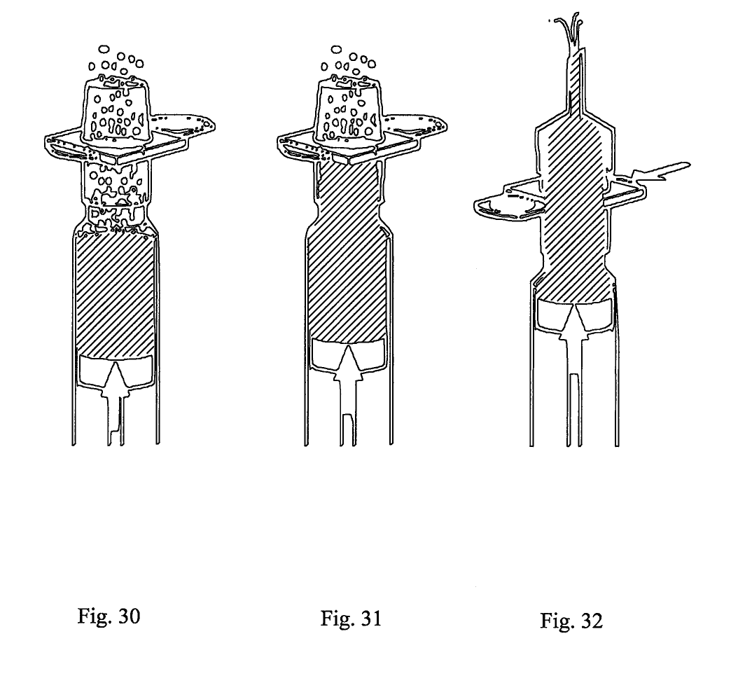

The design with the piston rod divided in two parts, with latches on the lower piston rod portion and the piston rod pipe having an upper end with a reduced inner diameter, that interacts with the ring shaped portions 28a, b is what makes the mixing process possible. In the first position, illustrated in FIG. 32, a first substance may be provided below the lower piston in the volume downwards delineated by the spout; a second substance between the lower piston and the middle piston; and a third substance between the middle piston and the upper piston. As the piston rod is pulled upwards, the lower piston is pulled up while the other pistons remain fixed. In this process, the sealing element 7 gives way and allows the second substance to flow into the volume where originally only the first substance were, and the two substance are mixed.

When the piston rod has reached its upper end position and the first and second substances have been fully mixed, the upper end of the piston rod pipe with a reduced diameter, locks against the upper ring shaped portion 28a, such that when the piston rod is pushed downwards, the upper piston follows downwards. Through the action of the liquid pressure acting on the middle piston and on the lower piston attached to the upper piston, these too are pushed downwards and the mixture of the first and the second substances are dispensed through the spout.

The middle piston is provided with a valve which normally is closed, but is opened when a sufficient pressure is applied. The lower piston comprises channels that extend from its centre towards its periphery. When the lower piston and the middle piston have reached the lowest position, the third substance is forced through the valve in the middle piston, along the channels in the lower piston to the sealing element and past these. In this stage, the third substance is thus dispensed.

FIG. 30 shows an eighth embodiment of the invention in a first position. The eighth embodiment does, like the previous ones, comprise a container with a narrowed spout portion 30 intended to receive a spout. Inside the container, a piston with a piston rod runs. The container has been partially filled with a liquid that fills the upper part of the container which extends from the upper surface of the piston and a distance upwards toward the end where the spout portion is arranged, which is in the upper part of the figure. The spout portion is essentially cylindrical and has at its mid section a recess, through which a flat double filter is insertable. The recess extends through a filter holder with a flat upper part and a flat lower part, where the upper and lower parts a joined along to opposing sided, while the two remaining sides are open and receive the double filter.

The double filter is a flat rectangular element with two filter openings. The double filter may be slid between to positions in the filter holders, such that one or the other filter opens for passage of gas or liquid through the spout portion via respective filter. In FIG. 34 one hydrophobic filter is set in place in the spout portion, such that air may be pressed through the filter and evacuates air from the interior of the container.

FIG. 31 shows the eighth embodiment of the invention in a second position, where the piston has been shifted upwards such that all air has been pushed through the hydrophobic filter and the liquid no engages the filter. FIG. 32 shows the eighth embodiment of the invention in a third position, where a spout 2 has been placed onto the spout portion and the double filter has been shifted such that the second filter is in position for use. The second filter filters away larger particles that should not be dispensed through the spout. In the figure, liquid has reached all the way to the mouth of the spout and it is ready to be dispensed.

In this document, the concept of lower, refers to the direction in which the spout is intended to be placed on the container, and upper means the opposite. The presented embodiments comprise two or three moveable pistons, but obviously the concept may be extended to any number of pistons. Also, various versions of piston rods are disclosed, but the general idea is obviously intended to include versions where the piston rod is divided in any number of parts. These may for example be arranged in a telescopic fashion, but other embodiments are conceivable.

1. A piston with a sealing element for slideably sealing a container with an essentially cylindrical inner surface, wherein the sealing element comprises an inner portion aligned against the piston and an outer ring portion which extends in a ring shape around the circumference of the piston and is arranged to engage the inner surface of the container, where the outer ring portion is arranged to flex inwards towards the centre axis of the piston when the piston is displaced inside container in a first direction and the outer ring portion is arranged to flex outwards towards the inner surface of the container when the piston is displaced inside the container in a second direction being opposite the first direction, and where further at least a first ring shaped groove extends in a ring shape on a first side of the sealing element, the groove being arranged between the inner portion and the outer ring portion of the sealing element.

2. A piston with a sealing element according to claim 1, wherein a second ring shaped groove extends in a ring shape on a second side of the sealing element, the groove being arranged between the inner portion and the outer ring portion of the sealing element, where the first groove is deeper than the second groove.

3. A piston with a sealing element according to claim 2, wherein outer ring portion of the sealing element is attached to the inner portion of the sealing element along a ring shaped attachment area which extends around its periphery, and where the outer ring portion extends further from the attachment area in a first direction being perpendicular to the centre axis of the piston, than in a second direction being opposite the first direction.

4. A piston with a sealing element according to claim 1, wherein a passage is generated allowing liquid to pass between the sealing element and the inner surface of the container, when the piston is pushed inside the container in the first direction.

5. A device for storing, mixing and dispensing of at least two substances, comprising a container with an essentially cylindrical inner surface and a piston with a sealing element for slideably sealing the container, where the container at a first end is arranged to comprise a spout, wherein the sealing element comprises an inner portion aligned against the piston and an outer ring portion which extends in a ring shape around the circumference of the piston and is arranged to engage the inner surface of the container, where the outer ring portion is arranged to flex inwards towards the centre axis of the piston when the piston is displaced inside container in a first direction and the outer ring portion is arranged to flex outwards towards the inner surface of the container when the piston is displaced inside the container in a second direction being opposite the first direction, and where further at least a first ring shaped groove extends in a ring shape on a first side of the sealing element, the groove being arranged between the inner portion and the outer ring portion of the sealing element.

6. A device for storing, mixing and dispensing according to claim 5, wherein a second ring shaped groove extends in a ring shape on a second side of the sealing element, the groove being arranged between the inner portion and the outer ring portion of the sealing element, where the first groove is deeper than the second groove.

7. A device for storing, mixing and dispensing according to claim 6, wherein the outer ring portion of the sealing element is attached to the inner portion of the sealing element along a ring shaped attachment area which extends around its periphery, and where the outer ring portion extends further from the attachment area in a first direction being perpendicular to the centre axis of the piston, than in a second direction being opposite the first direction.

8. A device for storing, mixing and dispensing according to claim 5, wherein a passage is generated allowing liquid to pass between the sealing element and the inner surface of the container, when the piston is pushed inside the container in the first direction.

9. A device for storing, mixing and dispensing according to claim 5, wherein to the piston is attached a piston rod which extends in the direction of the second end of the container, and where the container comprises and upper piston slideably arranged inside the container.

10. A device for storing, mixing and dispensing according to claim 9, wherein the piston and the upper piston comprise a locking device that may lock together the piston and the upper piston.
